(19) United States
(12) Patent Application Publication
(10) Pub. No.: US 2022/0071287 A1
(43) Pub. Date: Mar. 10, 2022

(54) ATOMIZER COMPRISING TWO HEATING WIRES

(71) Applicant: Shenzhen Eigate Technology Co., Ltd., Shenzhen (CN)

(72) Inventor: Tuanfang LIU, Shenzhen (CN)

(21) Appl. No.: 17/118,583

(22) Filed: Dec. 10, 2020

(30) Foreign Application Priority Data
Sep. 7, 2020 (CN) 202021933465.X

(51) Int. Cl. A24F 40/46; H05B 3/10

(52) U.S. Cl. CPC A24F 40/46; H05B 3/10

(57) ABSTRACT

An atomizer includes a ceramic core, a first heating wire, and a second heating wire. The ceramic core includes a body including a through hole. The first heating wire is soldered on the second heating wire.

### CROSS-REFERENCE TO RELATED APPLICATIONS

Pursuant to 35 U.S.C. § 119 and the Paris Convention Treaty, this application claims foreign priority to Chinese Patent Application No. 202021933465.X filed on Sep. 7, 2020, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to an atomizer comprising two heating wires.

Conventionally, the atomizer of the electronic cigarettes is spiral structure with a single cylindrical hole. Thus, the heating area of the atomizer is small and thus the electronic cigarettes can only produce a small amount of vapor.

### SUMMARY

The disclosure provides an atomizer, comprising a ceramic core, a first heating wire, and a second heating wire; the ceramic core comprises a body comprising a through hole; the first heating wire is soldered on the second heating wire.

In a class of this embodiment, the first heating wire and the second heating wire are coiled side by side in the through hole to form a helical structure.

In a class of this embodiment, the first heating wire is soldered on the second heating wire in parallel; and one end of each of the first heating wire is soldered on the second heating wire and is connected to a pin.

In a class of this embodiment, the through hole is cylindrical, and a coiled part of each of the first heating wire and the second heating wire is cylindrical and inlaid in an inner wall of the ceramic body surrounding the through hole.

In a class of this embodiment, the body of the ceramic core is cylindrical.

In a class of this embodiment, the first or second heating wire comprises one or more curved meshed structures, planar helical structures, spiral structures, or a combination thereof connected in series or in parallel.

In a class of this embodiment, the body of the ceramic core is in the shape of ellipsoid, flat ellipse, hemisphere, cone, bowl, triangle, quadrilateral, polygon; and the ceramic core is an equivalent of quartz, crystal, mica, agate, jade.

### BRIEF DESCRIPTION OF THE DRAWINGS

FIG. 1 is an exploded view of an atomizer in accordance with one embodiment of the disclosure;

FIG. 2 is a schematic diagram of an atomizer in accordance with one embodiment of the disclosure; and

FIG. 3 is a sectional view of an atomizer in accordance with one embodiment of the disclosure.

### DETAILED DESCRIPTION

To further illustrate, embodiments detailing an atomizer are described below. It should be noted that the following embodiments are intended to describe and not to limit the disclosure.

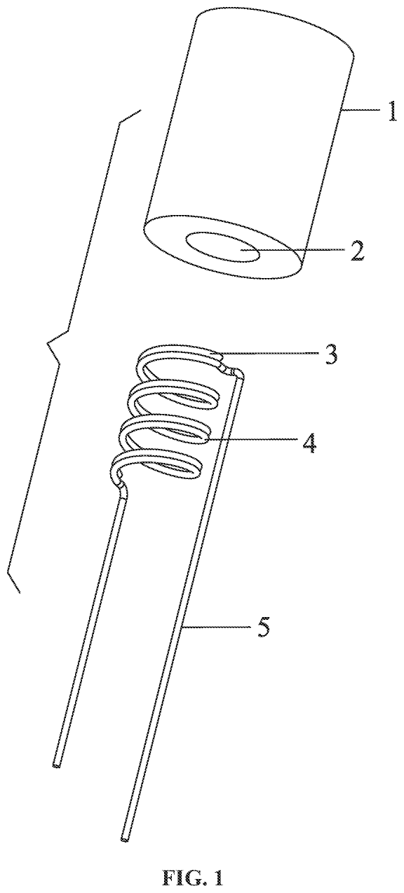

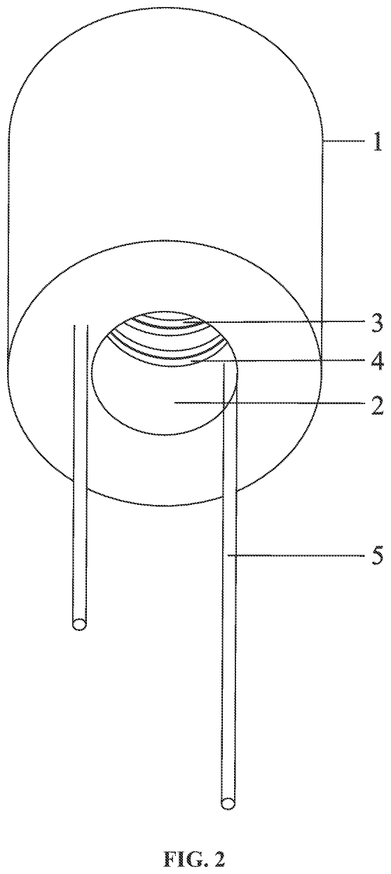

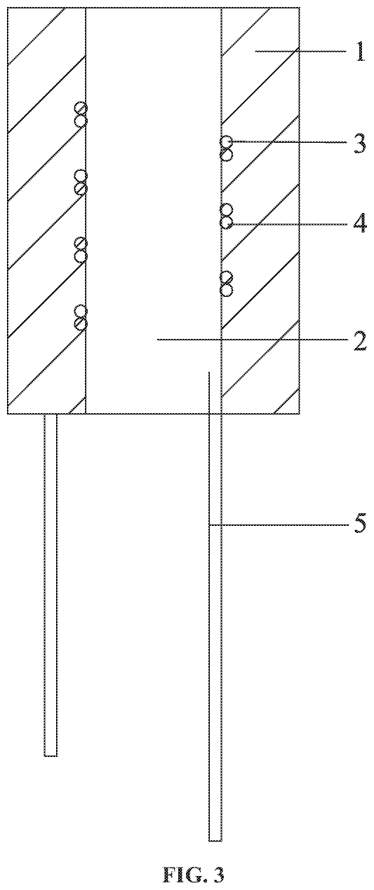

As shown in FIGS. 1-3, the disclosure provides an atomizer comprising a ceramic core 1, a first heating wire 3, a second heating wire 4, and a pin 5. The ceramic core 1 comprises a body comprising a through hole 2. The first heating wire 3 and the second heating wire 4 are coiled side by side in the through hole 2 to form a helical structure. In certain embodiment, the first heating wire 3 and the second heating wire 4 are embedded in the ceramic core, are exposed in the through hole 2, or are secured to the inner wall of the ceramic body surrounding the through hole. Optionally, the first heating wire 3 and the second heating wire 4 are disposed side by side. Two pins 5 are soldered on the first heating wire 3 and the second heating wire 4 respectively for electric conduction and produce heat. The heat is transferred to the ceramic core 1 to atomize the e-liquid.

In certain embodiments, the ceramic core is in the shape of ellipsoid, flat ellipse, hemisphere, cone, bowl, triangle, quadrilateral, polygon; and the ceramic core is an equivalent of quartz, crystal, mica, agate, jade. The first or second heating wire comprises one or more curved meshed structures, planar helical structures, spiral structures, or a combination thereof connected in series or in parallel. The body comprising one or more through holes in the shape of circle, ellipse, square, triangle and polygon.

The following advantages are associated with the atomizer of the disclosure:

1. The ceramic core comprises the first heating wire and the second heating wire coiled side by side in the through hole to form a helical structure, which enlarges the heating area, increases the heat value, accelerates temperature rise and increases the vapor amount.

2. The atomizer comprises two pins soldered on the first heating wire and the second heating wire respectively for electric conduction and produce heat.

3. The two metal heating wires are a helical structure and are soldered together in parallel, which is novel.

It will be obvious to those skilled in the art that changes and modifications may be made, and therefore, the aim in the appended claims is to cover all such changes and modifications.

What is claimed is:

1. A device, comprising a ceramic core, a first heating wire, and a second heating wire; wherein the ceramic core comprises a body comprising a through hole; the first heating wire is soldered on the second heating wire.

2. The device of claim 1, wherein the first heating wire and the second heating wire are coiled side by side in the through hole to form a helical structure.

3. The device of claim 2, wherein the first heating wire is soldered on the second heating wire in parallel; and one end of each of the first heating wire is soldered on the second heating wire and is connected to a pin.

4. The device of claim 3, wherein the through hole is cylindrical, and a coiled part of each of the first heating wire and the second heating wire is cylindrical and inlaid in an inner wall of the ceramic body surrounding the through hole.

5. The device of claim 4, wherein the body of the ceramic core is cylindrical.

6. The device of claim 5, wherein the first or second heating wire comprises one or more curved meshed structures, planar helical structures, spiral structures, or a combination thereof connected in series or in parallel.

7. The device of claim 6, wherein the body of the ceramic core is in the shape of ellipsoid, flat ellipse, hemisphere, cone, bowl, triangle, quadrilateral, polygon; and the ceramic core is an equivalent of quartz, crystal, mica, agate, jade.
